(19) United States
(12) Patent Application Publication
(10) Pub. No.: US 2007/0010950 A1
(43) Pub. Date: Jan. 11, 2007

(54) Method to determine the degree and stability of blood glucose control in patients with diabetes mellitus via the creation and continuous update of new statistical indicators in blood glucose monitors or free standing computers

(76) Inventors: Daniel S. Abensour, Coral Springs, FL (US); R. Mack Harrell, Boca Raton, FL (US)

Correspondence Address: DANIEL ABENSOUR, 6285 NW 120th DRIVE, CORAL SPRINGS, FL, 33076, US

(21) Appl. No.: 11/293,534

(22) Filed: Dec. 3, 2005

Related U.S. Application Data
(60) Provisional application No. 60/632,585, filed on Dec. 3, 2004.

(51) Int. Cl. G06F 19/00

(52) U.S. Cl. 702/19

(57) ABSTRACT

Microvascular complications of diabetes mellitus are closely related to blood glucose levels and fluctuations. The Glycostator statistical package was created to allow patients and health care providers simple access to “glycemic indicators” which permit a “snapshot view” of the effectiveness of the patient's diabetes management program. Glycostator functions provide a simple way of enhancing the information already provided by home blood glucose monitoring devices. To this end, a set of new indices, including one called the Virtual A1c, are computed in a recursive fashion from blood glucose test results to provide a more meaningful day-to-day assessment of glycemic control. All indices can be made available at the meter user interface on request. The displayed indices allow patients to improve glycemic control by identifying problems with blood glucose control and lability that are less easily recognized in traditional blood glucose meter statistical packages. Virtual A1c emulates hemoglobin A1c continuously and provides better day-to-day assessment of long term glycemic control than does the traditional average blood glucose report. The method for computing each of these indices, including the Virtual A1c, allows for their implementation in commercial blood glucose monitors.

This application continues from provisional application Ser. No. 60/632,585 filed on Dec. 03, 2004.

### BACKGROUND OF THE INVENTION

1. Field of Invention

The present invention uses new computed statistical indicators to assess the blood glucose control of patients with diabetes over a period of a few months, and allows for the incorporation and the computation of these indicators in the data screens of devices such as blood glucose monitors. The indicators computed from blood glucose test results include a Time Averaged Glucose (TAG) parameter, a simulation of the measurement of hemoglobin A1c called the Virtual A1c (V-A1c) and an indicator of blood glucose variability called the Lability Factor (LF). The method and the set of these indicators are called Glycostator. These indicators are functions of the patient's blood glucose test results over a specific period of time, as well as of the elapsed times between all these tests. The first new indicator is the Time Averaged Glucose. It gives an indication of blood glucose control normalized for the time interval between glucose tests. The second new indicator is the Virtual A1c (V-A1c or VA1c). It mimics the measurement of the blood hemoglobin A1c, which is currently the gold standard for long term assessment of blood glucose control. Finally, the Lability Factor is calculated, which allows patients, physicians and health plan managers to assess the degree of blood glucose variability over time. Blood glucose lability has recently been recognized to be an independent risk factor for diabetes related microvascular complications. In addition, the Lability Factor allows for an independent assessment of the reliability and accuracy of the Time Averaged Glucose and the Virtual A1c. All these new blood glucose functions can be computed by the microprocessor in any blood glucose meter or by download of blood glucose time stamped values into a free standing computer. This time encoded blood glucose information is already available in all commercial blood glucose monitoring devices. All parameters are tabulated in a recursive manner based on a simple update calculation which occurs each time a new test is performed, thereby allowing implementation in most current blood glucose meters without the requirement of additional processing power (as opposed to a complete re-calculation with every new test.) Thus, this invention immediately allows patients, physicians and health plan managers to access a simple summary of how tightly blood glucose has been controlled over the last few months and to assess the variability of glucose control over the same time frame without undertaking any additional blood drawing or testing.

The hemoglobin A1c blood test provides summarized information on blood glucose control over a 3 month period. This is the major reason for its popularity with endocrinologists and other diabetes practitioners, who do not have the time to review weeks of detailed daily blood glucose results. In healthy, non-diabetic patients, the hemoglobin A1c level is less than 5.5% of total hemoglobin, and long term studies have shown that the complications of diabetes can be delayed or even prevented if this level can be kept below 6.5%. Unlike fingerstick blood glucose tests that are readily performed by patients, the hemoglobin A1c level can only be measured in a reference laboratory or in the physician's office, making, availability an issue. Additionally, the hemoglobin A1c test can be misleading in certain medical circumstances and conditions, and as we will explain later, the test paradigm makes some assumptions that may occasionally reduce its accuracy in the evaluation of blood glucose control.

2. Background and Description of the Prior Art

Control of blood glucose requires frequent fingerstick glucose testing. Blood glucose monitors store time stamped test results and give running averages of the stored tests. The maximum amount of stored test results varies with the type of monitor, ranging from 30 data points to thousands. The running glucose average has some utility, but can be deceiving, especially for diabetes patients who suffer frequent wide swings of blood glucose from hypoglycemia (low blood glucose) to hyperglycemia (high blood glucose.) For example, if a blood glucose test is done during a hyperglycemic episode, with a blood glucose value of 190 mg/dl, followed by another glucose test during a hypoglycemia episode with a glucose value of 40 mg/dl, the 115 mg/dl average of these two tests may erroneously indicate reasonably good diabetes control and thereby, mislead the health care provider as well as the patient. Even more significantly, through a period of repeated highs and lows, the patient's diabetes may be completely out of control, and yet the average test value shown on the monitor may still be “normal.” Moreover, the computation of the average blood glucose value does not take into account the time dimension. Suppose that two tests are taken within a very short time frame showing near-identical results. When computing the average test value for a series of blood glucose results including the two similar results, these two values are effectively double counted, with a resulting averaging bias. Frequently, when patients find blood glucose results outside the normal range, they repeat the blood, test immediately (to make sure that it was correct the first time), and a distorted running average is calculated by meter software. A high (or low) blood glucose situation lasting a long time will have a more significant impact on the patient's health than high or low glucose levels persisting for only a short time. So it is imperative to take into account the time elapsed between the tests, which a traditional running glucose average does not do. Thus, in spite of being the most common statistic reported on blood glucose monitors today, the average glucose calculation often supplies information of limited utility and may be downright misleading. In today's blood glucose meters, there is no statistical construct which offers a time-normalized “snapshot view” of glycemic control. Patients, physicians and health care managers need a more sophisticated statistical analysis of glycemic control in order to make informed decisions about diabetes management.

3. Objectives
1—The main objective is to provide a “summary” of control during a specific period of time, similar to or better than the hemoglobin A1c blood test, but based on the fingerstick blood glucose tests performed and stored in the patients' blood glucose monitor.
2—This “summarized information” will have to be qualified in terms of its statistical significance. It may comprise several components, the most significant being the mean value of the blood glucose tests with time intervals taken into account (Time Averaged Glucose), a surrogate for the gold standard hemoglobin A1c called the Virtual A1c, and a measure of blood glucose variability, called the Lability Factor (measurement of the glycemic variability).
3—All these components will be computed using the microprocessor in a typical blood glucose meter without any need for increased processing power.

### BRIEF DESCRIPTION OF THE DRAWINGS

Various other objects, advantages, and features of the invention will become apparent in the following discussions and drawings, in which:

FIG. 1 is a representation of the function Ψ(t) representing the glucose concentration in blood as a function of time as it would be measured by a hypothetical continuous glucose metering device placed in the bloodstream. This continuous function is represented by a solid line and is sampled at the times t₀, t₁, . . . ,tₙ where it will take the values r₀, r₁, . . . ,rₙ given by the tests. Its value is not known outside of these test points.

FIG. 2 shows how we utilize the “Ψ(t)” function. To compute the mathematical average of this function we need to compute the value of the integral

$${\int }_{{t}_{0}}^{{t}_{n}} Ψ ( t ) ⅆ t$$

We are using the trapezoidal approximation as represented on FIG. 2.

FIG. 3 shows the impact of time on both the average test value and on the computation of V-A1c. It shows the different effect of 2 sets of 2 consecutive blood glucose tests Rᵢ, Rᵢ₊₁ and Rₖ, Rₖ₊₁ on the V-A1c as well as their impact on the average blood glucose calculation. As shown on FIG. 3, it is clear that the longer a patient remains in a hyperglycemic situation, the more significant will be the impact on his/her V-A1c.

FIG. 4 shows the relationship between hemoglobin A1c percentages and average plasma glucose concentrations.

FIG. 5 shows the results of a step by step computation of A* and of V-A1c.

FIG. 6 shows the result of the computations of the variance, the standard deviation and the Lability Factor. Again this computation is made based on the method that we have developed and will allow for our preferred embodiment on a traditional blood glucose meter.

FIG. 7 shows the flowchart utilized for the computation of the average of the approximated function Ψ(t). This flowchart is designed specifically to allow for implementation on a device with limited processing power and memory.

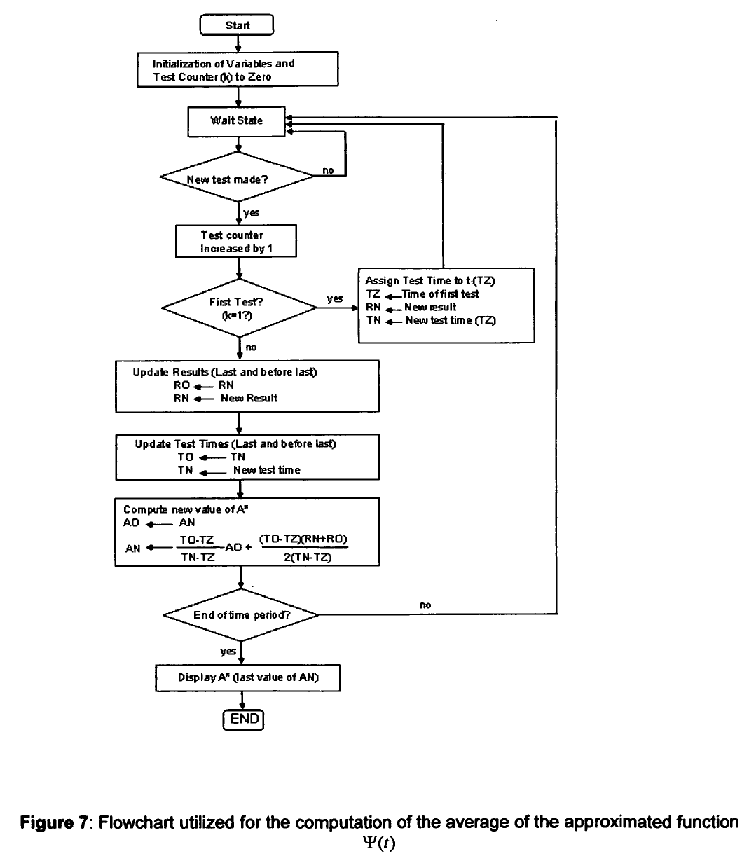

FIG. 8 shows the flowchart of our method to compute V-A1c on a traditional blood glucose meter.

FIG. 9 shows the flowchart, used to compute the Lability Factor with recursive relations requiring minimal-processing power.

FIG. 10 shows the Glycostator parameters: Time-Averaged Glucose, Virtual A1c and Lability Factor, calculated in an interactive implementation on a general purpose computer where the patient or a professional has downloaded the time stamped test results from a, blood glucose meter and then interactively selected one of several time periods to assess the patient's overall glycemic control.

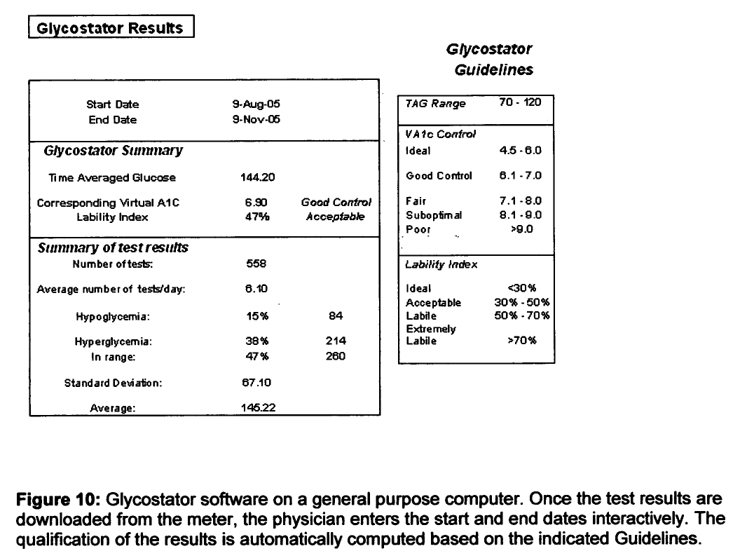

FIG. 11 shows the family of curves which are used to provide the γ coefficients applied to the test results. The test results are calculated in such a way that the most recent ones carry the heaviest weight; this approach simulates the decay curve of human, red blood cells.

### SUMMARY OF THE INVENTION

Reference is now made to the drawings, wherein like characteristics and features of the present invention shown in the various FIGURES are designated by the same reference numerals.

The present invention accomplishes the above-stated objectives as may be determined by a fair reading and interpretation of the entire specification. This invention is based upon the premise that blood glucose tests administered by the patient will remain the key determinant of home diabetes management.

Typically a set of 4 to 8 tests or more per day is considered necessary for maintenance of good control for type 1 diabetes patients. Even if the hemoglobin A1c blood test is made available to the patient for home use, this test will not: replace home blood glucose monitoring, which is the only way to decide immediately whether the patient needs to modify his/her medications because of unforeseen glycemic excursions.

In the near future, quasi-continuous blood or interstitial glucose testing with minimally invasive monitors, will become the norm, making sophisticated blood glucose statistical manipulation (like that provided by Glycostator) even more essential and time saving.

The invention will make use of the information already captured in the blood glucose monitor to produce a meaningful and constantly updated summary of the control of the blood glucose for the patient and for the physician. This summary will be composed of the following indicators:
1—The mathematical average of the test; value as a function of time over the time period, the time dimension playing a significant role. This will be called the Time-Averaged Glucose (TAG) or Indicator #1.
2—The Virtual Hemoglobin A1c (V-A1c), will simulate the actual measurement of HgbA1c in the blood over a specific window of time. This will be our Indicator #2.
3—The ratio of the standard deviation of the test-values during that period of time, to the Time Averaged Glucose-over this period of time will be known as the Lability Factor (LF) or Indicator #3.
4—The traditional average value of the tests during this period of time (without the time dimension) as provided currently in most blood glucose meters, though not part of this invention, will always be available. In meters implementing our invention, the traditional average will be qualified by our Indicator #1 (Time Averaged Glucose.)

As we have previously shown, the running glucose average, by itself, is not a good indication of glycemic control. So to enhance all the collected and processed blood glucose data, our invention uses the Time Averaged Glucose and the Virtual A1c as indices of “tightness of control.” Although the standard deviation of the blood glucose (already implemented in some currently available diabetes management software) provides one measure of the variation around the average value, we prefer to use our Lability Factor (ratio of standard deviation to the Time Averaged Glucose as a percentage) since in this application the Time Averaged Glucose is our gold standard. A “low” percentage indicates less variable blood glucose values and also lends credence to the Time Averaged Glucose and Virtual HgbA1c calculations (i.e. in this case the function Ψ(t) has a relatively low number of small “peaks and valleys”.)

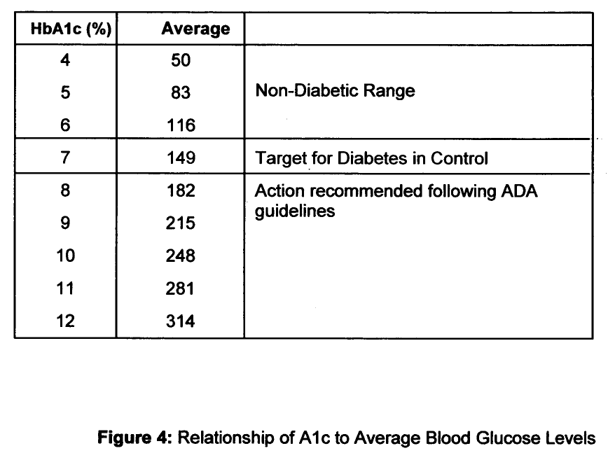

Adjunctive testing of hemoglobin A1c is highly recommended (every 3 months) for independent assessment of the glycemic control in type 1 and type 2 diabetes and for calibration of the Virtual A1c. Tables exist which 1) specify the level of control and 2) map the percentage of A1c hemoglobin to the mean blood glucose of the patient. FIG. 4 shows one of these tables.

Unfortunately, the hemoglobin A1c test is available only in physician offices and reference labs and has fundamental scientific flaws. The HgbA1c test does not take hypoglycemic episodes into account, but actually gives a “better” result because of low blood glucose events. Like the running average of blood glucose test results, the hemoglobin A1c decreases with hypoglycemic incidents of significant frequency or duration.

Since hemoglobin A1c is a direct product of the irreversible binding of ambient glucose to the hemoglobin pigment in red blood cells and since the red cells have an average half life of 60 days, there are 3 negative consequences which diminish the validity of the hemoglobin A1c measurement:
a) HgbA1c is necessarily weighted by more recent blood glucose values in the blood,
b) HgbA1c does not provide information on glycemic control more than 3 months prior and
c) HgbA1c is not accurate if red cell survival is altered by disease states such as renal failure, liver failure, hemoglobinopathy, blood loss or severe illness.

Consequently, quarterly hemoglobin A1c tests are required to quantify the evolution and the control of the disease (hemoglobin A1c tests are typically ordered every 3 months by diabetes professionals). Such testing may give an erroneously favorable impression of glycemic control in patients with anemia, liver disease and kidney disease resulting in undertreatment. Patients with abnormal hemoglobin molecules that electophoretically migrate in the same band as HgbA1c may exhibit artifactually elevated hemoglobin A1c values that could lead well intentioned health care providers to overtreat.

Our invention, the Glycostator, addresses these problems. If the blood glucose tests, on which these indicators are based, are sufficient in number and collected in the required time interval, then the Glycostator software will provide an accurate summary of the control-of blood glucose during that specific period. The following section provides the mathematical definition of these indicators.

Indicator #1: Time Averaged Glucose: A Mathematical Average of the Test Value as a Function of Time

If Ψ(t) is the test result value as a function of time, and if A is the average of this function to be computed over the period of time t₀ to tₙ, then A is given by the following formula:

$$A = \frac{1}{{t}_{n} - {t}_{0}} {\int }_{{t}_{0}}^{{t}_{n}} Ψ ( t ) ⅆ t \qquad ( 1 )$$

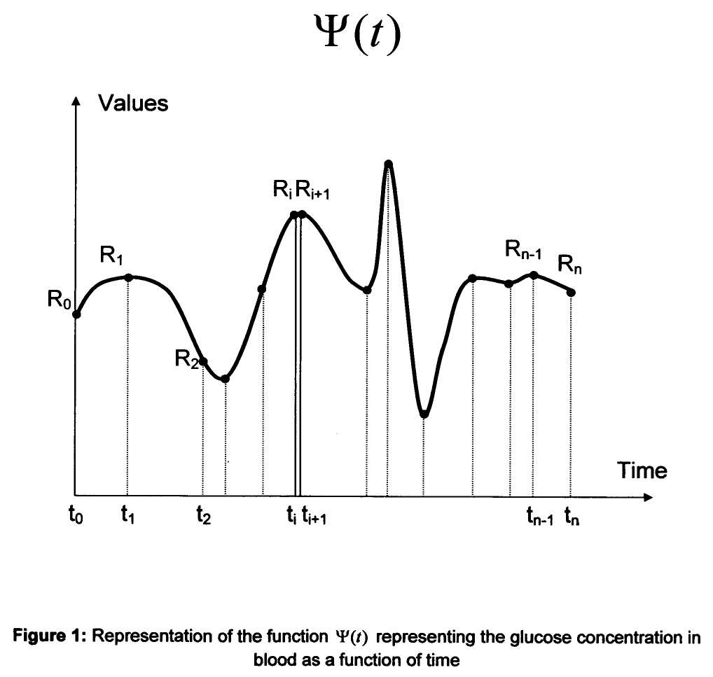

Note that for our application the function Ψ(t) is not continuous and is only defined on the test times t₀, t₁, . . . ,tₙ where it takes the values: R₀, R₁, . . . ,Rₙ FIG. 1 is a representation of the hypothetical function Ψ(t) representing the value of the glucose in the blood as a function of time.

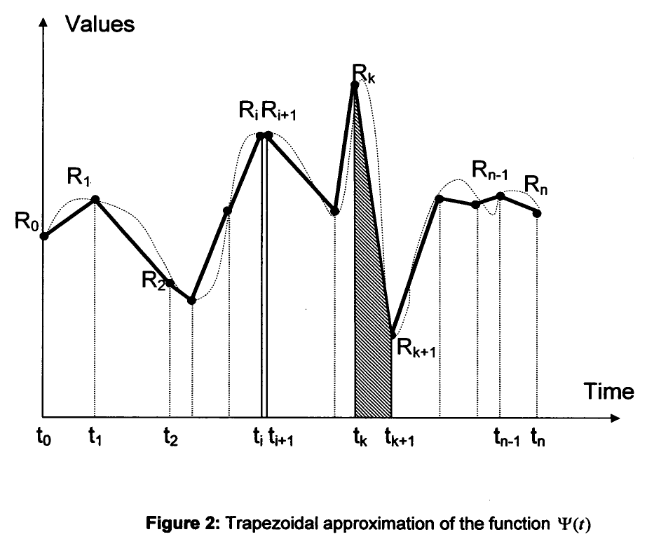

FIG. 2 shows how the function Ψ(t) is approximated. This is done by a sequence of segments joining the various known test points. The integral

$${\int }_{{t}_{0}}^{{t}_{n}} Ψ ( t ) ⅆ t$$

is approximated by the trapezoids method. The trapezoid corresponding to the test points Rₖ and Rₖ₊₁ has a value of:

$${A}_{k} = \frac{1}{2} ( {R}_{k} + {R}_{k + 1} ) ( {t}_{k + 1} - {t}_{k} ) \qquad ( 2 )$$

and therefore the average of the approximated function Ψ(t) between t₀ and tₙ (equation 1) is given by A*:

$${A}^{*} = \frac{1}{2 ( {t}_{n} - {t}_{0} )} {\sum }_{k = 0}^{n - 1} ( {R}_{k} + {R}_{k + 1} ) ( {t}_{k + 1} - {t}_{k} ) \qquad ( 3 )$$

A*, the mathematical average of the test value as a function of time over the time period, will be used as our indicator #1 or the “Time Averaged Glucose.”
Indicator #2: Virtual Hemoglobin A1c

As indicated earlier, we are defining a new index, V-A1c to mimic the measurement of hemoglobin A1c in the blood. To compute V-A1c over a specific sliding window of time, we are going to use the integral of the function “test result value” vs. time, with the blood glucose test values during the specific period. A 3 month period is the recommended length of time required if one: wants to follow the actual creation of hemoglobin A1c in the blood, but unlike hemoglobin A1c, V-A1c (and A*) can be evaluated over a period of arbitrary length.

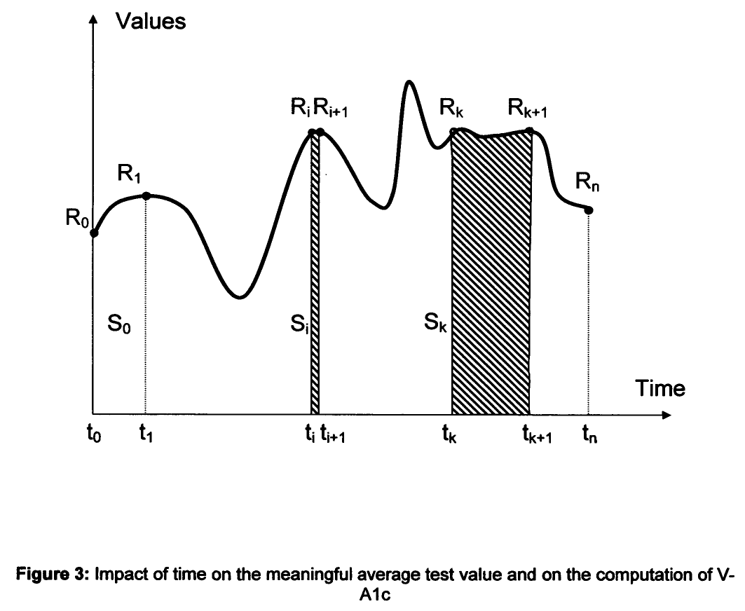

Our approach eliminates the “double counting” of tests close in time and simulates the natural creation of hemoglobin A1c in the blood. For example, as exposed in FIG. 3, if 2 (or more) consecutive, high blood glucose tests Rₖ and Rₖ₊₁ are separated by a long period of time, their contribution to V-A1c is higher than if these consecutive tests are separated by a shorter period of time like tests Rᵢ and Rᵢ₊₁.

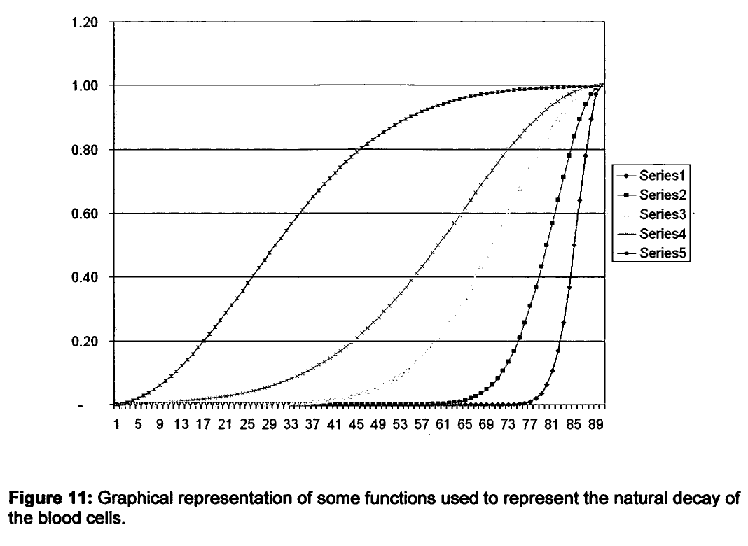

In addition we are weighing each test result Rₖ by a coefficient γᵢ which is an increasing function of the distance in time between the beginning of the period (usually 3 month) and the time of the actual test. This γ coefficient varies between 0 and 1. The tests given at the start of the period (usually 3 months old when the latest test is taken) have a multiplying coefficient close to 0, and the most recent tests, (those given at the end of the period) have their multiplying coefficient close to 1. This is done to simulate the half life of the red cells. FIG. 11 shows a graphical representation of some functions which are well suited to represent the natural decay of the blood cells. These functions belong to the same mathematical family and are parameterized. Two variations are used:

$$γ ( d ) = {α}^{- {( \frac{90 - d}{β} )}^{2}}$$

where γ is a function of the variable d (for day number) and α and β are parameters. The second variation is:

$$γ ( d ) = 1 - {α}^{- {( \frac{d}{β} )}^{2}} .$$

The selection of the parameters was based on the best V-A1c approximation of hemoglobin A1c actual results.

In summary, the γ coefficient is a function of the date when the test is done, relative to the start of the test period. For the aforementioned simulation it is sufficient to measure γ in days, but it could be expressed in smaller time units if desired. For example if the selected period is 90 days, one can have a sequence of γ coefficients like γ₁,γ₂, . . . ,γ₉₀ where the γₙ coefficient applies to all the test results of day n.

Consequently the V-A1c indicator is derived from formula (3) by introducing the half life of the red cells factor with each test result Rₖ multiplied by the coefficient γⱼ with the weight satisfying the relations: 0≦γⱼ≦1 and γⱼ≦γⱼ₊₁ (i indicates the test date and k the number of the test result.)

To compute the V-A1c indicator we will first use the same approach as for A* but replacing Rₖ+Rₖ₊₁ by their weighted values γ^{j,k}Rₖ+γ_{j,k+1}Rₖ₊₁ where k represents the test number and j the day of the test.

Then the following formula (4) gives us C*, average value of the tests weighted by the γ_{j,k} coefficients.

$${C}^{*} = \frac{1}{2 ( {t}_{n} - {t}_{0} )} {\sum }_{k = 0}^{n - 1} ( {γ}_{j , k} {R}_{k} + {γ}_{j , k + 1} {R}_{k + 1} ) ( {t}_{k + 1} - {t}_{k} ) \qquad ( 4 )$$

In order to emulate hemoglobin A1c we apply a linear regression formula correlating average glucose and hemoglobin A1c that is accepted worldwide by diabetes practitioners and approved by the ADA. This linear relation between μ (test average) and A1c, developed from large scale diabetes treatment trials is:
μ=33A1c−82 or:

$$A 1 c = \frac{μ}{33} + \frac{82}{33} \qquad ( 5 )$$

So our indicator V-A1c is given by the formula:

$$VA 1 c = \frac{1}{66 ( {t}_{n} - {t}_{0} )} {\sum }_{k = 0}^{n - 1} ( {γ}_{j , k} {R}_{k} + {γ}_{j , k + 1} {R}_{k + 1} ) ( {t}_{k + 1} - {t}_{k} ) + \frac{82}{33} \qquad ( 6 )$$

As we indicated before, the notation γ_{i,k} indicates that the γ coefficient is a function of the date on which the k^{th} test was performed. Equation (6) does not lend itself to a formal recursive calculation since the γ coefficient depends on a different variable than its rank, specifically, the time interval from the origin of the time frame selected. As a result, the evaluation of V-A1c in a general purpose computer may use equation (6) with the γ coefficients directly computed (several functions can be used to approximate the exponential decay of the red cells.) In a limited processing environment, like a blood glucose meter, it is appropriate to use a different approach where the γ coefficient values are directly extracted from a table based on the “age” of the test.

It is also important to note that if the linear relation between μ (test average) and A1c changes, or even if this relation is not expressed as a linear relation, V-A1c will still a direct function of C* and only Formula (6) will need to be changed (the coefficients of the linear relation between the average glucose value and HgA1c have already been modified several times in the last few years.) The method to compute V-A1c, explained later, will remain entirely applicable.

Indicator #3: Lability Factor: The “Measure” of Glycemic Variability

The ratio of the standard deviation over the timed average of the test values is expressed as a percentage making the concept interpretable by lay persons and health care providers alike. If μₙ is the average of the test values for the test period t₀, tₙ the standard deviation of the test values is given by:

$$E = \sqrt{\frac{{\sum }_{i = 0}^{n} {( {R}_{i} - {μ}_{n} )}^{2}}{n}} \qquad ( 7 )$$

and our indicator #3, the “Lability Factor”, is given by:

$$Q = \frac{E}{{A}^{*}} \qquad ( 8 )$$

### DETAILED DESCRIPTION OF THE PREFERRED EMBODIMENTS

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriate detailed structure.

The preferred embodiment will be as microcode, software or firmware inside a blood glucose meter. Any or all of our indicators can be displayed each time the meter is turned on, and/or on demand. The Glycostator indicators are updated after every blood glucose test.

The secondary embodiment will be as software on a computer. This computer will have the capability of downloading test data (value of the test and date/time of the test) from the patient's blood meter. Formulas (3), (6), and (8) can be directly programmed on any general purpose computer, to yield the calculation of our 3 indicators.

### Preferred Embodiment and Method

The following methods are designed for a blood glucose meter implementation. A recursive method is used to compute the standard deviation and other indicators in order to minimize the required processing power and memory of the device used. This is an important consideration when the device is a blood glucose meter but only of marginal importance if the device is a general purpose computer.

1. Method to compute Indicator #1. Time Averaged Glucose

This iterative method is utilized to compute indicator #1 which represents the mathematical average of the test value as a function of time. As seen earlier A* is given by the equation:

$${A}^{*} = \frac{1}{2 ( {t}_{n} - {t}_{0} )} {\sum }_{k = 0}^{n - 1} ( {R}_{k} - {R}_{k + 1} ) ( {t}_{k + 1} - {t}_{k} ) \qquad ( 3 )$$

The direct computation of A* is impossible in a blood glucose meter, but it presents no difficulty in a general purpose computer. We will call Aₖ* the value of the indicator A* after the test # k. We have:

$${A}_{k}^{*} = \frac{{\sum }_{i = 0}^{k} {S}_{i}}{( {t}_{k + 1} - {t}_{0} )} \qquad ( 9 )$$

where Sᵢ is the area of the trapezoid approximating the integral of the Ψ(t) function between tests Rᵢ and Rᵢ₊₁. Sᵢ is given by:

$$Si = \frac{1}{2} ( {t}_{i + 1} - {t}_{i} ) ( {R}_{i} + {R}_{i + 1} ) \qquad ( 10 )$$

Similarly to (6) we have Aₖ₋₁* given by:

$${A}_{k - 1}^{*} = \frac{{\sum }_{i = 0}^{k - 1} {S}_{i}}{( {t}_{k} - {t}_{0} )} \qquad ( 11 )$$

Subtracting (11) from (9) gives us:

$$\begin{matrix}( {t}_{k + 1} - {t}_{0} ) {A}_{k}^{*} = ( {t}_{k} - {t}_{0} ) {A}_{k - 1}^{*} + {S}_{k} & ( 12 ) \\ {S}_{k} = \frac{1}{2} ( {t}_{k + 1} - {t}_{k} ) ( {R}_{k} + {R}_{k + 1} ) & ( 13 )\end{matrix}$$

(12) and (13) give us the recursive relation (14) which, with the initial value A₀*. (15) allows the iterative computation of:the Indicator # 1.

$$\begin{matrix}{A}_{k}^{*} = \frac{{t}_{k} - {t}_{0}}{{t}_{k + 1} - {t}_{0}} {A}_{k - 1}^{*} + \frac{( {t}_{k + 1} - {t}_{k} ) ( {R}_{k} + {R}_{k + 1} )}{2 ( {t}_{k + 1} - {t}_{0} )} & ( 14 ) \\ {A}_{0}^{*} = \frac{1}{2} ( {R}_{0} + {R}_{1} ) & ( 15 )\end{matrix}$$

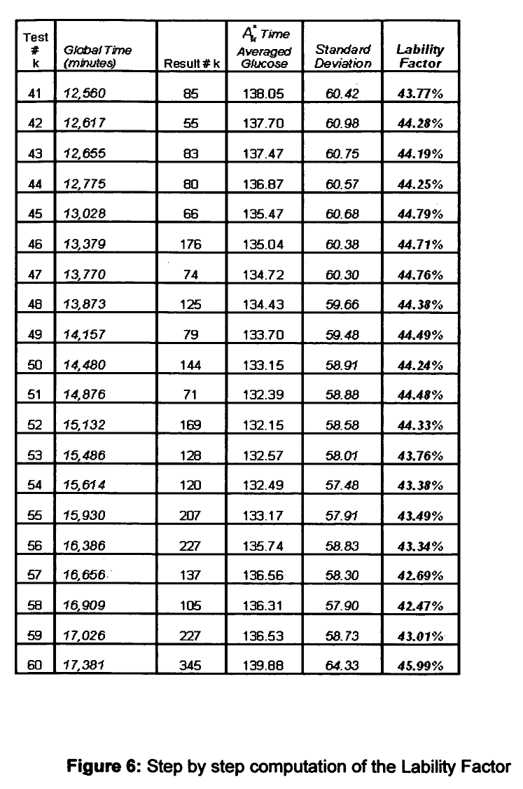

To obtain this result, exactly 6 additions, 3 multiplications and 2 divisions must be performed with each new test. FIG. 6 shows a detailed flow chart of our method the implementation of the recursive relation (14) with the initial condition (15) at a low processing cost. The following variables are used in the flow chart with, between parentheses, the corresponding name used in the above equations:
TZ Time of the first test (t₀)
RN New Result (Rₖ₊₁)
RO Old Result (Rₖ)
TN Time of New result (tₖ₊₁)
TO Time of Old (previous) result (tₖ)
AN A* New value (Aₖ*)
AO A* Old (previous) value (Aₖ₊₁*)

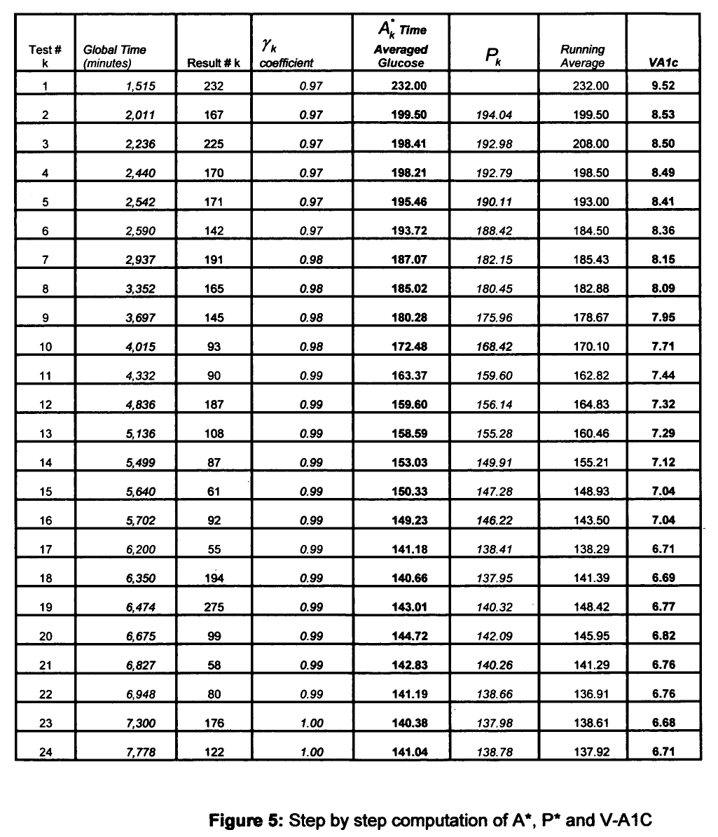

The table on FIG. 5 shows an example of the computation of A* step by step.

2. Method to compute Indicator #2: Virtual Hemoglobin A1c

We have seen the linear relation between weighted average C* and VA1c, so we will first compute C* as defined by equation (4):

$${C}^{*} = \frac{1}{2 ( {t}_{n} - {t}_{0} )} {\sum }_{k = 0}^{n - 1} ( {γ}_{j , k} {R}_{k} + {γ}_{j , k + 1} {R}_{k + 1} ) ( {t}_{k + 11} - {t}_{k} ) \qquad ( 4 )$$

Because of the response time constraints and the impracticality of the computation of the γ coefficients at each step, we have developed two different implementations for the evaluation of C. First, for an implementation of equation (4) on a low processing power device (like a traditional blood glucose meter), it is best to store the pre-computed γ values in a table (approximately 90 values, 1 per day for 90 days) and use our iterative approach. At each step of the computation, we perform a table consultation to determine the 2 values of the corresponding γⱼ and γⱼ₊₁ coefficients required. Second, for an implementation on a traditional computer, we skip the iterative method and we directly compute all the parts of (4) including the γⱼ and γⱼ₊₁, coefficients using the exponential decay function mentioned earlier.

We can then proceed exactly as we did for Indicator#1. Calling Pₖ the value of C* after test k and Uᵢ the “cell” defined by the tests Rᵢ and Rᵢ₊₁ we have:

$$\begin{matrix}Ui = \frac{1}{2} ( {γ}_{j , i} {R}_{i} + {γ}_{j , i + 1} {R}_{i + 1} ) ( {t}_{i + 1} - {t}_{i} ) & ( 16 ) \\ {P}_{k} = \frac{{\sum }_{i = 0}^{k} {U}_{i}}{( {t}_{k + 1} - {t}_{0} )} & ( 17 )\end{matrix}$$

As previously described, subtracting, Pₖ₋₁ from Pₖ gives us the recursive relation between Pₖ₋₁ and Pₖ defined by (18) and (19), thus allowing the iterative computation of the indicator:

$$\begin{matrix}{P}_{k} = \frac{{t}_{k} - {t}_{0}}{{t}_{k + 1} - {t}_{0}} {P}_{k - 1} + \frac{( {t}_{k + 1} - {t}_{k} ) ( {γ}_{j , k} {R}_{k} + {γ}_{j + 1 , k + 1} {R}_{k + 1} )}{2 ( {t}_{k + 1} - {t}_{0} )} & ( 18 ) \\ {P}_{0} = \frac{1}{2} ( {γ}_{0} {R}_{0} + {γ}_{1} {R}_{1} ) & ( 19 )\end{matrix}$$

The “computing cost” per step for C* is 6 additions, 5 multiplications and 2 divisions after each new test (not including the table consultation required for the determination of the γ coefficients). Some of these calculations can be combined with those required for the computation of Aₖ* (our indicator #1.) From each value of Pᵢ we can apply the already defined relation (5) to compute VA1c at the additional cost of 1 addition and 1 division

$$( \frac{82}{33} is a constant . )$$

$$VA 1 c = \frac{{C}^{*}}{33} + \frac{82}{33} \qquad ( 20 )$$

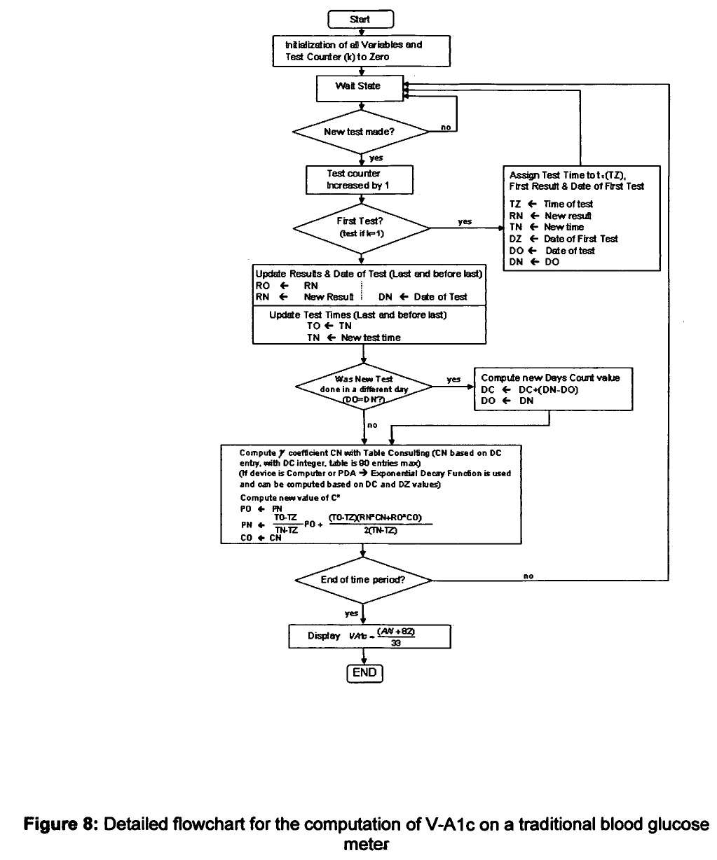

FIG. 8 shows a detailed flow chart for the low implementation of the recursive relation (18) with the initial condition (19) and the calculation of VA1c. The following variables are used in the flow chart:
TZ Time of the first test (t₀)
RN New Result (Rₖ₊₁)
RO Old Result (Rₖ)
TN Time of New result (tₖ₊₁)
TO Time of Old (previous) result (tₖ)
DZ Date of First Test (Start of the evaluation period)
DN Date of New test
DO Date of Old (previous) test
DC Day Counter (counts days since first test)
CN γ coefficient for New result (γ_{j,k})
CO γ coefficient for Old (previous) result (y_{j+1,k+1})
PN New value of C* (Pₖ₊₁)
PO Old (previous) value of C* (Pₖ)

The table on FIG. 5 shows an iterative computation of VA1c based on our method.

3. Method to compute Indicator #3: Lability Factor

We are defining our Indicator #3 as the ratio of the standard deviation to the mean value μₙ of the tests during the time period considered. In order to establish a recursive relation, we are using the variance of the test results, which is the square of the standard deviation and which is given by:

$${V}_{n} = \frac{1}{n} {\sum }_{i = 0}^{n} {( {R}_{i} - {μ}_{n} )}^{2} \qquad ( 21 )$$

Rᵢ is test result #i and μₙ is the average of the test results R₀ to Rₙ. μₙ is given by

$${μ}_{n} = \frac{1}{n + 1} {\sum }_{i = 0}^{n} {R}_{i} .$$

Expanding (21) we obtain:

$$\begin{matrix}{nV}_{n} = {\sum }_{i = 0}^{n} {R}_{i}^{2} - 2 {μ}_{n} {\sum }_{i = 0}^{n} {R}_{i} + ( n + 1 ) {μ}_{n}^{2} & \\ {nV}_{n} = {\sum }_{i = 0}^{n} {R}_{i}^{2} - \frac{1}{n + 1} {( {\sum }_{i = 0}^{n} {R}_{i} )}^{2} & ( 22 ) \\ ( n - 1 ) {V}_{n - 1} = {\sum }_{i = 0}^{n - 1} {R}_{i}^{2} - \frac{1}{n} {( {\sum }_{i = 0}^{n - 1} {R}_{i} )}^{2} & ( 23 )\end{matrix}$$

From the relation

$${μ}_{n} = \frac{1}{n + 1} {\sum }_{i = 0}^{n} {R}_{i}$$

we also obtain:

$${μ}_{n} = \frac{n}{n + 1} {μ}_{n - 1} + \frac{{R}_{n}}{n + 1} \qquad ( 24 )$$

with the initial values:

$${μ}_{0} = {R}_{0} and {μ}_{1} = \frac{{R}_{0} + {R}_{1}}{2}$$

In order to get the recursive relation for the variance, we subtract (23) from (22) and using (24) we obtain:

$${V}_{n} = \frac{n - 1}{n} {V}_{n - 1} + \frac{1}{n} {R}_{n}^{2} - \frac{n + 1}{n} {μ}_{n}^{2} + {μ}_{n - 1}^{2} \qquad ( 25 )$$

with the initial values:

$${V}_{0} = 0 and {V}_{1} = \frac{1}{2} {( {R}_{0} - {R}_{1} )}^{2} \qquad ( 26 )$$

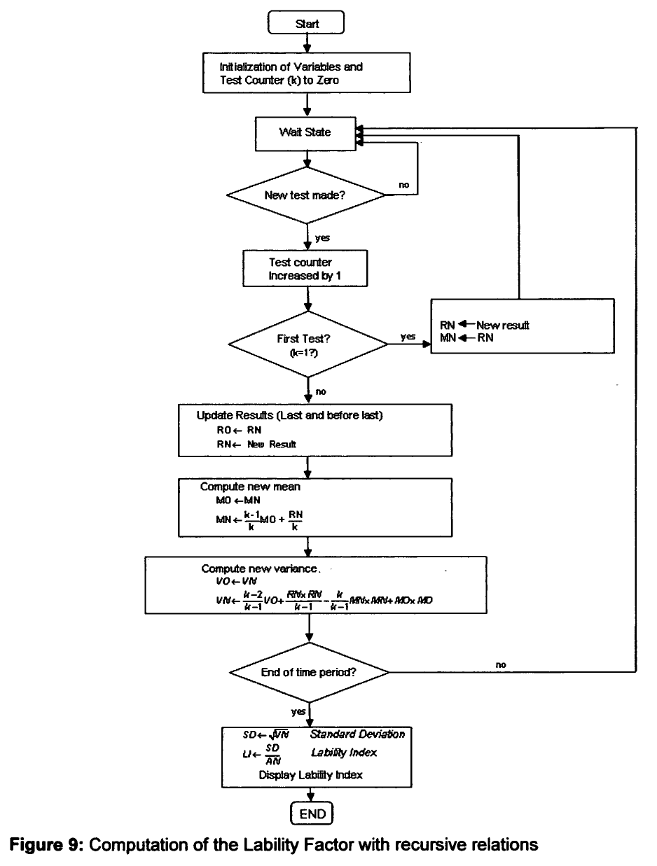

The recursive relation (25), with the initial conditions (26), allows the step by step computation of the variance. Once we have the variance, we calculate the standard deviation (square root of the variance) and then we express the Lability. Factor as the ratio of the standard deviation to the Time Averaged Glucose A*. This indicator #3 is provided at the cost per step of 9 additions, 3 multiplications, 6 divisions and a square root (including the computation of the Time Averaged Glucose.) FIG. 9 shows a detailed flow chart for the low implementation of the recursive relation (25) with the: initial condition (26) and the calculation of the Lability Factor. The following variables are used in the flow chart:
RN New Result (Rₖ₊₁)
RO Old Result (Rₖ)
MN New Mean value of the tests (μₖ)
MO Old mean value of the tests (#μₖ₋₁)
VN New value of Variance (Vₖ₊₁)
VO Old (previous) value of Variance (Vₖ)
SD Standard deviation.
LF Lability Factor

FIG. 6 shows an example of the iterative computation of the variance, the standard deviation and the Lability Factor using our method. Because traditional blood glucose meters do not have much processing power; it takes several seconds to display the running average of the test results on these machines. Adding new indicators is only acceptable if it does not impact response time and if it does not necessitate a costly redesign of the meter.

The preferred embodiment of the present invention, a blood glucose monitor, is: thus described. While the present invention has been described in particular embodiments, the present invention should not be construed as limited by such embodiments, but rather, according to the claims below.

What we claim is:

1. A method for enhanced statistical analysis of blood glucose monitoring data called “Glycostator” consisting of 3 new parameters of diabetes control: (1) Time Averaged Glucose (TAG), (2) Virtual A1c (A1c) and (3) Lability Factor (LF).

2. A method for calculation of the parameter from claim (1) called “Time Averaged Glucose (TAG),” consisting of a trapezoidal approximation of the integral of blood glucose concentration over time and yielding a more accurate estimate of glucose control than the traditionally employed running average blood glucose feature employed on most blood glucose devices in the United States.

3. A method for calculation of the parameter from claim (1) called “Virtual A1c (VA1c),” derived from TAG and emulating the commonly used laboratory test called hemoglobin A1c, with the capability of providing patients, health care providers and health plan managers a time normalized “snapshot view” of diabetic blood glucose control without having to perform the laboratory based hemoglobin A1c test, currently considered the gold standard for assessment of diabetes control and eliminating some of the drawbacks of this test.

4. A method for calculation of the new parameter from claim (1) called “ability Factor (LF)” derived from TAG and based on the concept of coefficient of variation for blood glucose, representing the variability of blood glucose values and indirectly assessing the reliability of VA1c in addition to promoting the conclusions of the recent research which suggests that glycemic variability may be an independent risk factor for the development of microvascular complications in diabetes mellitus.

5. A method for iteratively calculating the Time Averaged Glucose, Virtual A1c and Lability Factor over a specific period of time using recursive formulas that can easily be implemented on existing platforms (blood glucose monitors already in the marketplace) with minimal requirements for processing and memory.

6. A method for directly computing the Time Averaged Glucose, Virtual A1c and Lability Factor components of claim 1 on a general purpose computer or on a personal data assistant (PDA) platform, including the steps of:
downloading the test data from the blood glucose meter on the general purpose computer or on the PDA, data including for each test: date, time and test values;
selecting a time period to cover the assessment of the diabetes management;
approximating the continuous function of blood glucose vs time with the discrete sequence of time stamped test results;
using this timed sequence to compute the Time Averaged Glucose by approximating the average of the continuous function of blood glucose vs time over the assessment period, this approximation consisting in using a numerical analysis approach to determine the numerical value of the integral of the function blood glucose vs time over the assessment period;
using the weighing of each test result by a coefficient between 0 and 1 with the curvature of the above sequence simulating the aging of the red cells and their progressive decay and allowing the computation of the Virtual A1c parameter;
computing the ratio of the standard deviation of the original test value sequence to the Time Averaged Glucose previously determined to provide the Lability Factor.
